(19) United States
(12) Patent Application Publication
(10) Pub. No.: US 2008/0131800 A1
(43) Pub. Date: Jun. 5, 2008

(54) Toners and toner methods

(75) Inventors: Daniel Griggs Marsh, Webster, NY (US); Gerald Phillip Cox, Brockport, NY (US); Eugene F. Young, Rochester, NY (US); Mark E. Mang, Rochester, NY (US)

Correspondence Address: MARYLOU J. LAVOLE, ESQ. LLC, 1 BANKS ROAD, SIMSBURY, CT, 06070, US

(73) Assignee: Xerox Corporation

(21) Appl. No.: 11/903,531

(22) Filed: Sep. 20, 2007

Related U.S. Application Data
(60) Provisional application No. 60/872,333, filed on Dec. 2, 2006.

(51) Int. Cl. G03C 1/795; G03G 15/08; G03G 15/20

(52) U.S. Cl. 430/59.6; 399/286; 399/336

(57) ABSTRACT

A device including a charging component; a developing component; a transport component; a photoconductive component; and a radiant fusing component; wherein the development component contains a toner comprising at least one crystalline polymer, optionally an amorphous polymer, and at least one colorant.

### RELATED APPLICATIONS

This application claims the benefit of U.S. Provisional Application Ser. No. 60/872,333, filed Dec. 2, 2006, which is hereby incorporated by reference herein in its entirety.

### BACKGROUND

The present disclosure is generally related to toners, developers containing toners, processes thereof, and methods for generating developed images with, for example, imaging devices employing radiant fusing components. More specifically, in embodiments, thereof, the present disclosure relates to radiant fusing toners comprising, for example, a crystalline polymer, an optional amorphous polymer, and a colorant, and in embodiments to imaging processes employing the described toners in an imaging device, for example in embodiments, a xerographic device using radiant fusing.

In the art of electrophotography, a photoreceptor, imaging member, or the like, comprising a photoconductive insulating layer on a conductive layer is imaged by first uniformly electrostatically charging the surface of the photoconductive insulating layer. The photoreceptor is then exposed to a pattern of activating electromagnetic radiation such as light, which selectively dissipates the charge in the illuminated areas of the photoconductive insulating layer while leaving behind an electrostatic latent image in the non-illuminated areas. There are also photoreceptor technologies where the discharged area develops the image. This electrostatic latent image may then be developed to form a visible image by depositing finely divided electroscopic toner particles on the surface of the photoconductive insulating layer. The resulting visible toner image can be transferred to a suitable receiving member and permanently fixed thereto using either a heat and pressure mechanism or a radiant fusing technology to melt and bond the toner particles to the media being printed on, for example, paper. This imaging process may be repeated many times with reusable photoconductive insulating layers.

U.S. Pat. No. 6,850,725, which is hereby incorporated by reference herein in its entirety, discloses in the Abstract an apparatus comprised of a charging component, a development component, a transport component, a photoconductive component, and a fusing component, and wherein the development component contains a toner comprising at least one binder in an optional amount of from about 85 to about 99 percent by weight, at least one colorant in an optional amount of from about 0.5 to about 15 percent by weight, and calcium stearate in an optional amount of from about 0.05 to about 2 percent by weight and wherein following triboelectric contact with carrier particles, the toner has a charge Q measured in femtocoulombs per particle diameter D measured in microns (Q/D) of from about −0.1 to about −1 fC/μm with a variation during development of form about 0 to about 0.25 fC/μm and wherein the distribution is substantially unimodal and possesses a peak width of from about 0.1 fC/μm to about 0.5 fC/μm and the toner possesses a charge to mass M, as measured in grams, ratio (Q/M) of form about −25 to about −70 μC/gram with variation of Q/M during development of from about 0 to about 15 μC/gram.

Numerous processes are known for the preparation of toners, such as, for example, conventional polyester processes wherein a resin is melt kneaded or extruded with a pigment, micronized and pulverized to provide toner particles of the desired volume average particle diameter and geometric size distribution. In such processes, wherein large materials are mechanically reduced in size to achieve the desired smaller toner particles, it is usually necessary to subject the aforementioned toners to a classification procedure such that the desired size and geometric size distribution is attained. Also, in the aforementioned conventional process, low toner yields after classification may be obtained. For example, during the preparation of toners with average particle size diameters of from about 11 microns to about 15 microns, toner yields range from about 70 percent to about 85 percent after classification, and during the preparation of smaller sized toners with particle sizes of from about 7 microns to about 10 microns, lower toner yields may be obtained after classification, such as from about 50 percent to about 70 percent.

As an improvement to the foregoing mechanical reduction processes, processes are known in which the toner is achieved via aggregation as opposed to particle size reduction. For example, emulsion/aggregation/coalescing processes for the preparation of toners are illustrated in a number of Xerox patents, the disclosures of which are totally incorporated herein by reference in their entireties, such as U.S. Pat. Nos. 5,290,654, 5,278,020, 5,308,734, 5,370,963, 5,344,738, 5,403,693, 5,418,108, 5,364,729, and 5,346,797. Also of interest may be U.S. Pat. Nos. 5,348,832, 5,405,728, 5,366,841, 5,496,676, 5,527,658, 5,585,215, 5,650,255, 5,650,256, and 5,501,935, the disclosures of which are each totally incorporated by reference herein in their entireties.

U.S. Pat. No. 5,962,177, which is hereby incorporated by reference herein in its entirety, discloses developer and toner compositions containing linear polyesters and processes for the preparation and use thereof.

Radiant fusing can be categorized into two methods, infrared fusing, which can employ, for example, quartz lamps, and flash fusing, which can employ, for example, flash lamps.

Many currently available toners use low molecular weight polyesters as binders. These toners can be problematic in radiant fusing devices because of their high viscosities at fusing temperatures and relative hardness at development, housing and shipping temperatures. One problem encountered is the occurrence of a fused exterior with an unfused center section due to the high viscosities of low molecular weight toners at fusing temperatures. In addition, high viscosities make it difficult to achieve good fix with flash fusing. Flash fusing is incompatible with, for example, styrene based materials due to depolymerization and odor issues.

The appropriate components and process aspects of the each of the foregoing may be selected for the present disclosure in embodiments thereof.

### SUMMARY

Embodiments disclosed herein include a device comprising a charging component; a developing component; a transport component; a photoconductive component; and a radiant fusing component; wherein the development component contains a toner comprising at least one crystalline polymer, in embodiments at least one crystalline polyester, optionally an amorphous polymer, in embodiments, an optional amorphous polyester, and at least one colorant.

Embodiments disclosed herein further include a toner method comprising at least one crystalline polymer, in embodiments at least one crystalline polyester, used with a radiant fusing device which provides a substantially uniform fusing result due to low viscosities during the fusing event.

Further embodiments disclosed herein include a process for preparing a fused, printed image on a paper substrate comprising printing and fusing an image on a paper substrate using a device comprising a charging component, a developing component, a transport component, a photoconductive component, and a radiant fusing component, wherein the developing component contains a toner comprising at lest one crystalline polymer, optionally an amorphous polymer, and at least one colorant; and wherein, in embodiments, the fused, printed image has a crease value of less than about 60.

As used herein, crystalline polymer, for example, crystalline polyester, means a polymer (e.g., polyester) having at least some degree of crystallinity, wherein crystalline as used herein is intended to encompass both semi-crystalline and fully crystalline polyester materials. The polymer is considered crystalline when it is comprised of crystals with a regular arrangement of its atoms in a space lattice. An amorphous polymer, on the other hand, lacks such an organized crystalline structure and lacks a defined melting point.

In addition, embodiments disclosed herein include an image forming apparatus for forming images on a recording medium comprising 1) a photoreceptor member having a charge retentive surface to receive an electrostatic latent image thereon, wherein said photoreceptor member comprises a metal or metallized substrate, a charge generating layer, and a single-layer charge transport layer or a two-layer charge transport layer, wherein the charge transport layer or layers comprises a charge transport material; 2) a development component to apply a developer material to said charge-retentive surface to develop said electrostatic latent image to form a developed image on said charge-retentive surface, said development component comprising a toner comprising at least one crystalline polymer, in embodiments at least one crystalline polyester, optionally an amorphous polymer, in embodiments an amorphous polyester, and at least one colorant; 3) a transfer component for transferring said developed image from said charge-retentive surface to another member or a copy substrate; and 4) a radiant fusing member to fuse said developed image to said copy substrate. In embodiments, the recording medium selected is paper and a fused, printed image on the paper has a crease value of less than about 60.

### BRIEF DESCRIPTION OF THE DRAWING

The FIGURE is a visual reference scale for evaluating crease.

### DETAILED DESCRIPTION

Described herein are devices comprising a charging component; a developing component; a transport component; a photoconductive component; and a radiant fusing component; wherein the developing component contains a toner comprising at least one crystalline polymer, in embodiments at least one crystalline polyester, optionally an amorphous polymer, in embodiments an optional amorphous polyester, and at least one colorant.

In addition to crystalline polyesters, any suitable crystalline toner resin that exhibits a sharp viscosity drop as a function of temperature can be used for embodiments herein, for example, including but not limited to, crystalline polyethylene resin.

As used herein, crystalline polymer, for example crystalline polyester, means a polymer having at least some degree of crystallinity, wherein crystalline as used herein is intended to encompass both semi-crystalline and fully crystalline polymer materials. The polymer is considered crystalline when it is comprised of crystals with a regular arrangement of its atoms in a space lattice. An amorphous polymer, on the other hand, lacks such an organized crystalline structure and lacks a defined melting point.

Further described herein are methods comprising using toner compositions in an imaging device including a radiant fusing component, for example in embodiments an electrostatographic device, a xerographic device, which employs a radiant fuser, for example an infrared (for example quartz lamp) or a flash lamp (white light). The toner can comprise a mixture of resins which include at least one crystalline polymer (for example at least one crystalline polyester) and optionally include one or more amorphous polymers (for example, one or more amorphous polyesters) which are selected to achieve the desired rheology. The toner can be matched with a wide array of external additives, colorants, internal additives, including waxes, and carriers. The toners can be processed for example by melt mix and grind/classify or emulsion aggregation for example polyester emulsion aggregation. In embodiments, the crystalline polyester is advantageously employed in a radiant fusing system due to the lower flow temperature of the crystalline polyester compared to a conventional amorphous resin at fusing temperatures in combination with the crystalline polyester being relatively hard at development, housing and shipping temperatures. The radiant fusing toner described herein is formulated differently from, for example, roll fusing toners, since the radiant fusing toner does not need the elasticity required for hot offset resistance.

In embodiments, toners herein have a viscosity selected to be sufficiently low at coalescence/fusing temperatures encountered with radiant fusers so that sufficient penetration of the substrate occurs. For example, if the substrate is paper, the viscosity of the molten toner is selected to be low enough such that the toner is able to sufficiently penetrate the paper fibers to form a permanent image. Because flash fusing does not apply pressure like with pressure roller fusing, the viscosity is the driving factor for fusing performance. If the toner viscosity is too high during the fusing, the image will not be permanent and the image will flake off of the substrate. In embodiments, toners herein have a viscosity selected to be sufficiently low at coalescence/fusing temperatures encountered with radiant fusers so that sufficient penetration of the substrate occurs while also providing sufficiently high viscosity to avoid problems with blocking and excessive impaction due to lower temperature softness. In further embodiments, for color, an increase in gloss can be achieved without the use of an additional fuser on the system, due, for example, to the lower viscosity at the surface especially for solid areas.

Low viscosity resins selected herein can include any suitable low viscosity resin, in embodiments, low viscosity resins as used herein mean a resin having a viscosity of from about 10 poise to about 2000 poise at a temperature of from about 120° C. to about 160° C. Specific embodiments of suitable low viscosity resins include, but are not limited to, for example, linear polyesters, crystalline polyesters, polyethylene resins, and waxes among others, and mixtures and combinations thereof. These low viscosity resins may be mixed with higher viscosity amorphous resins to optimize the viscosity for specific machine requirements such as fusing energy, speed, etc.

Embodiments of the present disclosure include a device, for example a xerographic device, comprising a charging component; a developing component; a transport component; a photoconductive component; and a radiant fusing component; wherein the development component contains a toner comprising at least one crystalline polymer, in embodiments at least one crystalline polyester, optionally an amorphous polymer, in embodiments an amorphous polyester, and at least one colorant. The crystalline and amorphous resins can be selected at any suitable quantity and can comprise mixtures and combinations of resins as desired to achieve a desired rheology. The developing component includes in embodiments a developer comprising a toner as described herein and a carrier.

Embodiments disclosed herein include a method comprising using a toner including a crystalline polymer, for example, a crystalline polyester, used with a radiant fusing device which provides a substantially uniform fusing result due to low viscosities during the fusing event.

It is noted that radiant fusing is a very rapid process. Therefore the toner temperature does not have time to equal the fuser temperature.

In embodiments, the at least one crystalline polymer, in embodiments the at least one crystalline polyester, can be selected in various effective amounts. For example, in embodiments, the at least one crystalline polyester can be selected in an amount of from about 10 percent to about 80 percent by weight based upon the total weight of the toner. In further embodiments, the at least one crystalline polyester can be selected in an amount of from about 20 to about 60 percent by weight based upon the total weight of the toner.

Any suitable crystalline polymer can be selected in embodiments here. For example, any suitable crystalline polyester can be selected for the present toners including, for example, crystalline polyesters resin selected from the group consisting of crystalline polyesters prepared with an alcohol selected from among 1,4-butanediol, 1,6-hexanediol, dihydroxyhexane, 1,10-decanediol, and mixtures thereof with a dicarboxylic acid selected from among fumaric acid, succinic acid, oxalic acid, adipic acid, sebacic acid, and mixtures and combinations thereof. The crystalline polyester may be a crystalline polyester such as detailed in U.S. Pat. Nos. 6,653,435 and 6,780,557, each of which are totally incorporated herein by reference. For example, the crystalline polyester may be obtained by polycondensing an alcohol component comprising about 80% by mole or more of an aliphatic diol having from about 2 to about 6 carbon atoms, or from about 4 to about 6 carbon atoms, with a carboxylic acid component comprising about 80% by mole or more of an aliphatic dicarboxylic acid compound having from about 2 to about 8 carbon atoms, or from about 4 to about 6 carbon atoms or about 4 carbon atoms. See, for example, U.S. Pat. No. 6,780,557. The aliphatic diol having 2 to 6 carbon atoms may include ethylene glycol, 1,2-propylene glycol, 1,3-propylene glycol, 1,4-butanediol, 1,5-pentanediol, 1,6-hexanediol, neopentyl glycol, 1,4-butanediol, and the like. It is desirable that the aliphatic diol is contained in the alcohol component in an amount of about 80% by mole or more, such as from about 85% to about 100% by mole. The alcohol component may also contain a polyhydric alcohol component other than the aliphatic diol having from about 2 to about 6 carbon atoms. Such a polyhydric alcohol component includes a divalent aromatic alcohol such as an alkylene (2 to 3 carbon atoms) oxide adduct (average number of moles added being 1 to 10) of bisphenol A, such as polyoxypropylene (2.2)-2,2-bis(4-hydroxyphenyl) propane and polyoxyethylene (2.2)-2,2-bis(4-hydroxyphenyl) propane; a trihydric or higher polyhydric alcohol component such as glycerol, pentaerythritol and trimethylolpropane; and the like. The aliphatic dicarboxylic acid compound having from about 2 to about 8 carbon atoms includes oxalic acid, malonic acid, maleic acid, fumaric acid, citraconic acid, itaconic acid, glutaconic acid, succinic acid, adipic acid, acid anhydrides thereof, alkyl (1 to 3 carbon atoms) esters thereof, and the like. It is desirable that the aliphatic dicarboxylic acid compound is contained in the carboxylic acid component in an amount of about 80% by mole or more, such as from about 85% to about 100% by mole. Among them, from the viewpoint of the storage ability of the crystalline polyester, it is desirable that fumaric acid is contained in the carboxylic acid component in an amount of about 60% by mole or more, such as about 70 to about 100% by mole. The carboxylic acid component may contain a polycarboxylic acid component other than the aliphatic dicarboxylic acid compound having from about 2 to about 8 carbon atoms. Such a polycarboxylic acid component includes aromatic dicarboxylic acids such as phthalic acid, isophthalic acid and terephthalic acid; aliphatic dicarboxylic acids such as sebacic acid, azelaic acid, n-dodecylsuccinic acid and n-dodecenylsuccinic acid; alicyclic carboxylic acids such as cyclohexanedicarboxylic acid; tricarboxylic or higher polycarboxylic acids such as 1,2,4-benzenetricarboxylic acid (trimellitic acid) and pyromellitic acid; acid anhydrides thereof, alkyl (1 to 3 carbon atoms) esters thereof, and the like.

The crystalline polyester can also be derived from monomers containing an alcohol component comprising a trihydric or higher polyhydric alcohol, and a carboxylic acid component comprising a tricarboxylic or higher polycarboxylic acid compound as detailed in U.S. Pat. No. 6,653,435, which is hereby incorporated by reference herein in its entirety. The trihydric or higher polyhydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, and the like. Examples of the tricarboxylic or higher polycarboxylic acid compound include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, acid anhydrides thereof, alkyl (1 to 3 carbon atoms) esters thereof, and the like.

The aforementioned crystalline polyester materials may be prepared by any suitable or desired method, including by polycondensation reactions, for example, the polycondensation reactions described in the aforementioned patents.

In embodiments, the crystalline polyester material may be derived from a monomer system comprised of an alcohol selected from among 1,4-butanediol, 1,6-hexanediol, 1,10-decanediol, dihydroxyhexane, and mixtures thereof with a dicarboxylic acid selected from among fumaric acid, succinic acid, oxalic acid, adipic acid, sebacic acid, and mixtures thereof. For example, in one embodiment, the crystalline polyester may be derived from 1,4-butanediol and fumaric acid.

In embodiments, the crystalline polyester may have a melting point of from about 65° C. to about 123° C., or from about 70° C. to about 115° C.

Examples of crystalline polyester toner compositions for selection herein can include polyester toner compositions disclosed in U.S. Pat. No. 5,962,177 of Guerino G. Sacripante, et al., which is hereby incorporated by reference herein in its entirety.

In embodiments, crystalline polyesters are selected wherein the melting point of the crystalline polyester is defined as from about Tg+1° C. to about Tg+60° C., where Tg is the midpoint glass transition temperature of the amorphous resin.

Any suitable amorphous polymer can be selected for the optional amorphous polymer herein. An amorphous polyester can be selected in embodiments herein. If present, the optional amorphous polyester can be selected at any suitable amount, for example, in embodiments, the optional amorphous polyester can be present in an amount of from about 20 percent to about 90 percent by weight based upon the total weight of the toner, or about 40 to about 80 percent by weight based upon the total weight of the toner. In selected embodiments, for example, the optional amorphous polyester can be present at from about 40 percent to about 80 weight percent based upon the total weight of the toner and the at least one crystalline polyester can be present in an amount selected at from about 20 percent to about 60 percent by weight based upon the total weight of the toner.

The optional amorphous polyester, when present, can comprise any suitable resin or resin blend. Illustrative examples of suitable materials selected for the amorphous polyester material include polyesters such as the polymeric esterification products of a dicarboxylic acid and a diol comprising a diphenol. The esterification product of an aliphatic alcohol and an isophthalic acid may also be used. The amorphous polyester may be a homopolymer or copolymer of two or more monomers. As one resin, there are selected polyesters derived from a dicarboxylic acid and a diphenol. These resins are illustrated in, for example, U.S. Pat. No. 3,590,000, the disclosure of which is totally incorporated herein by reference. Suitable amorphous polyester materials that are commercially available include GTUF and FPESL-2 from Kao Corporation, Japan, and EM181635 from Reichhold, Research Triangle Park, N.C., and the like.

In embodiments, the optional amorphous polyester may be obtained from the reaction of bisphenol A and propylene oxide or propylene carbonate, and in particular including such polyesters followed by the reaction of the resulting product with fumaric acid (reference U.S. Pat. No. 5,227,460, the disclosure of which is totally incorporated herein by reference). For example, the amorphous polyester can comprise a polypropoxylated bisphenol A fumarate polyester. The amorphous polyester can comprise a linear propoxylated bisphenol A fumarate resin available under the trade name SPARII from Resana S/A Industrias Quimicas, Sao Paulo Brazil.

Toners and toner resins herein can be combined, melt blended or mixed with colorant, charge carrier additives, surfactants, emulsifiers, pigment dispersants, flow additives, embrittling agents and the like. In embodiments, toners herein comprise one or a combination of components selected from the group consisting of a wax component, a charge additive, a surface additive, an internal additive, a surfactant, a colorant, an emulsifier, a pigment dispersant, a flow additive, an embrittling agent, and mixtures and combinations thereof.

In embodiments, waxes with, for example, a low molecular weight (Mw) of from about 1,000 to about 10,000, such as polyethylene, polypropylene, and paraffin waxes, can be included in or on the toner compositions as, for example, fusing release agents.

Various suitable colorants of any color can be present in the toners, including suitable colored pigments, dyes and mixtures and combinations thereof. For example, suitable colorants can include, but are not limited to, for example, REGAL 330® (Cabot), Acetylene Black, Lamp Black, Aniline Black, magnetites, such as Mobay magnetites MO8029™, MO8060™, Columbian magnetites, MAPICO BLACKS™, and surface treated magnetites, Pfizer magnetites CB4799™, CB5300™, CB5600™, MCX6369™, Bayer magnetites, BAYFERROX 8600™, 8610™, Northern Pigments magnetites, NP-604™, NP-608™, Magnox magnetites TMB-100™, or TMB-104™, and the like, cyan, magenta, yellow, red, green, brown, blue or mixtures and combinations thereof, such as specific phthalocyanine HELIOGEN BLUE L6900™, D6840™, D7080™, D7020™, PYLAM OIL BLUE™, PYLAM OIL YELLOW™, PIGMENT BLUE1™, available from Paul Uhlrich and Company, Inc., PIGMENT VIOLET 1™, PIGMENT RED 48™, LEMON CHROME YELLOW DCC 1026™, E.D. TOLUIDINE RED™, and BON RED C™, available from Dominion Color Corporation, Ltd., Toronto, Ontario, NOVAPERM YELLOW FGL™, HOSTAPERM PINK E™, from Hoechst, and CINQUASIA MAGENTA available from E.I. DuPont de Nemours & Company, and the like. Generally colored pigments and dyes that can be selected include cyan, magenta, or yellow pigments or dyes, or mixtures or combinations thereof. Examples of magentas the can be selected include, but are not limited to, for example, 2,9-dimethyl-substituted quinacridone and anthraquinone dye identified in the Color Index as CI-60710, CI Dispersed Red 15, diazo dye identified in the Color Index as CI-26050, CI Solvent Red 19, and the like. Other colorants are magenta colorants of (Pigment Red) PR81:1, CI-45160:3. Illustrative examples of cyans that can be selected include but are not limited to copper tetra(octadecyl sulfonamide) phthalocyanine, x-copper phthalocyanine pigment listed in the Color Index as CI-74160, CI Pigment Blue, and Anthrathrene Blue, identified in the Color Index as CI-69810, Special Blue X-2137, and the like; while illustrative examples of yellows that can be selected include but are not limited to diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Form Yellow SE?GLN, CI Dispersed Yellow 33 2,5-dimethoxy-4-sulfonailide phenylazo-4′-chloro-2,5-dimethoxy acetoacetanilides, and Permanent Yellow FGL, PY17, CI 21105, and known suitable dyes, such as red, blue, green Pigment Blue 15:3 C.I. 74160, Pigment Red 81:3 C.I. 45160:3, and Pigment Yellow 17 C.I. 21105, and the like, reference for example U.S. Pat. No. 5,556,727, the disclosure of which is totally incorporated herein by reference.

In embodiments, the colorant selected is carbon black, magnetite, or mixtures or combinations thereof, cyan, magenta, yellow, blue, green, red, orange, violet, brown, or mixtures or combinations thereof.

In general, the colorant, for example the pigment or dye or combination thereof, is selected, for example, in an amount of from about 2 to about 60 percent by weight or from about 2 to about 9 percent by weight for color toner and from about 3 to about 60 percent by weight for black toner, based upon the total weight of the toner.

Any suitable surface additive or additives can be selected for the toner compositions in embodiments herein. Such surface additives include SiO₂ and TiO₂ additives, SiO₂ and TiO₂ surface treated with compounds including but not limited to decyltrimethoxysilane (DTMS) or hexamethyldisilazane (HMDS). Examples of additives include, but are not limited to, for example, surface treated fumed silicas, for example TS-530® (from Cabosil® Corporation, with an 8 nanometer particle size and a surface treatment of HMDS, coated with a mixture of HMDS and aminopropyltriethoxysilane, DTMS silica from Cabot Corporation comprised of a fumed silica silicon dioxide core L90® coated with DTMS, H₂0₅0EP from Wacker Chemie coated with an amino functionalized organopolysiloxane, metal oxides such as TiO₂, for example MT-3103® from Tayca Corp. with a 16 nanometer particle size and a surface treatment of decylsilane, SMT5103® from Tayca Corporation comprised of a crystalline titanium dioxide core MT500B® coated with DTMS, alternate metal oxides such as aluminum oxide, and as a lubricating agent, for example, stearates or long chain alcohols, such as UNILN 700®, as external surface additives. In general, silica is applied to the toner surface for toner flow, triboelectric enhancement, admix control, improved development and transfer stability, and higher toner blocking temperature. TiO₂ is applied for improved relative humidity (RH) stability, triboelectric control and improved development and transfer stability.

Stearic acid salts such as calcium stearate or zinc stearate can be selected as an additive for the toners disclosed herein in embodiments. For example, in embodiments, zinc stearate can be added to provide in embodiments primarily lubricating properties. Further, in embodiments, zinc stearate can provide developer conductivity and triboelectric enhancement, both due to its lubricating nature. In addition, in embodiments, zinc stearate can be added to enable higher toner charge and charge stability by increasing the number of contacts between toner and carrier particles.

In embodiments, the toners selected herein can comprise fatty acid salts, for example, calcium stearate, zinc stearate, and the like, or mixtures or combinations thereof, at any suitable amount. For example, in embodiments, zinc stearate can be selected in an amount of, for example, from about 0.05 to about 2 percent by weight based upon the total weight of the toner.

In another embodiment, for example, a commercially available zinc stearate can be selected with greater than about 85 percent purity, for example, from about 85 to about 100 percent pure. In yet another embodiment, toners can be selected to contain from, for example, about 0.1 to about 5 weight percent titania, about 0.1 to about 8 weight percent silica, and about 0.1 to about 4 weight percent calcium stearate, zinc stearate, or a combination thereof, based on the total weight of the toner.

Additives can be selected in embodiments to enable superior toner flow properties, high toner charge and charge stability. For example, surface treatments on SiO₂ and TiO₂, the relative amounts of the various additives, for example selecting about 90 percent silica to about 10 percent titania, by weight, can be manipulated to provide a range of toner charge values, for example from about 10 microcoulombs per gram to about 60 microcoulombs per gram, as measured by the standard Faraday Cage technique. For further enhancing the positive charging characteristics of the toner developer compositions, and as optional components there can be incorporated into the toner or on its surface charge enhancing additives inclusive of, but not limited to, alkyl pyridinium halides, reference U.S. Pat. No. 4,298,672, the disclosure of which is totally incorporated herein by reference, organic sulfate or sulfonate compositions, reference U.S. Pat. No. 4,338,390, the disclosure of which is totally incorporated herein by reference, distearyl dimethyl ammonium sulfate, bisulfates, and the like, and other similar known charge enhancing additives. Also, negative charge enhancing additives can be selected, such as but not limited to aluminum complexes, for example, BONTRON E-88™, and the like. These additives can be incorporated into the toner in any suitable amount, such as for example, in an amount of from about 0.1 percent by weight to about 20 percent by weight, or from about 1 to about 3 percent by weight, based on the total weight of the toner.

The toner compositions for use herein can be prepared by a number of known methods including but not limiting to melt blending the toner resin particles and pigment particles or colorants, followed by mechanical attrition. Other methods include those well known in the art such as spray drying, melt dispersion, dispersion polymerization, extrusion, and emulsion/aggregation processes.

The toner in embodiments can be generated by first mixing the binder, for example comprising at least one crystalline polyester, and if present, the optional amorphous polyester or resin blend as illustrated herein and the colorant together in a mixing device, for example, an extruder, and then preparing, for example, extruding, the mixture. The extruded mixture is then micronized in a grinder. Surfaces additives if selected can be micronized therewith. For example, the extruded mixture can be micronized in a grinder along with about 0.3 to about 0.5 weight percent of the total amount of silica to be used as an external additive. Optionally, the toner can be then classified to form a toner with the desired volume median particle size and percent fines. Subsequent toner blending of the remaining external additives is then accomplished for example using a mixer or blender, for example a Henschel mixer, followed by screening to obtain the final toner product. In embodiments, the toner product is blended with the external surface additives in a manner to enable even distribution and firm attachment of the surface additives, for example by using a high intensity lender. The blended toner achieved has the appropriate level and stability of toner flow and triboelectric properties.

Emulsion aggregation processes can be selected for preparation of the toners herein. For example, emulsion/aggregation/coalescing processes for the preparation of toners are illustrated in a number of Xerox patents, such as U.S. Pat. Nos. 5,290,654, 5,278,020, 5,308,734, 5,370,963, 5,344,738, 5,403,693, 5,418,108, 5,364,729, and 5,346,797, the disclosures of each of which are totally incorporated herein by reference. Also of interest may be U.S. Pat. Nos. 5,348,832, 5,405,728, 5,366,841, 5,496,676, 5,527,658, 5,585,215, 5,650,255, 5,650,256, 5,501,935, 5,723,253, 5,744,520, 5,763,133, 5,766,818, 5,747,215, 5,827,633, 5,853,944, 5,804,349, 5,840,462, and 5,869,215, the disclosures of each of which are totally incorporated herein by reference.

The resulting toner particles can then be formulated into a developer composition. For example, in embodiments, the toner particles are mixed with carrier particles to achieve a two-component developer composition (also termed herein a development component). In another embodiment, a single component development system can be selected.

In embodiments, the devices disclosed herein include a radiant fusing component selected from an infrared fusing device and a flash fusing device.

In further embodiments, an image forming apparatus for forming images on a recording medium comprises 1) a photoreceptor member having a charge retentive surface to receive an electrostatic latent image thereon, wherein said photoreceptor member comprises a metal or metallized substrate, a charge generating layer, and a single-layer charge transport layer or a two-layer charge transport layer, wherein the charge transport layer or layers comprises a charge transport material; 2) a development component to apply a developer material to said charge-retentive surface to develop said electrostatic latent image to form a developed image on said charge-retentive surface, said development component comprising a toner comprising at least one crystalline polyester, optionally an amorphous polyester, and at least one colorant; 3) a transfer component for transferring said developed image from said charge-retentive surface to another member or a copy substrate; and 4) a radiant fusing member to fuse said developed image to said copy substrate.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

Table 1 provides compositions for Control Toner #1 and Toners 2-5. The toners shown in Table 1 were prepared by combining the ingredients and tumbling for 20 minutes. The tumbled mixture was melt mixed in an APV 15 mm twin screw co-rotating extruder (Model MP2015, extruder available from APV Chemical Machines, Saginaw, Mich.). The resulting toners were ground using an 0₂0₂ grinder available from Fluid Energy and Processing Equipment Company (Hatfield, Pa.) to a median particle size of about 7 to about 9 microns. Due to limited quantities of extruded toner, only the control toner was further size classified. Toners #2 through toner #5 were used as-is from the 0202 grinder. Flow and charging agents were dry blended onto the toner surface using a Fuji mill to enhance flow and charging properties. Developers were made by mixing the resulting blended toners with carrier. Unfused prints were made using a known Xerographic printer. These prints were transferred to a Xerox® 650 CF printer with a flash fuser. The flash fuser has 4 lamps and a process speed of 300 fpm was used. The unfused prints were taped to the web and advanced through the flash fuser housing.

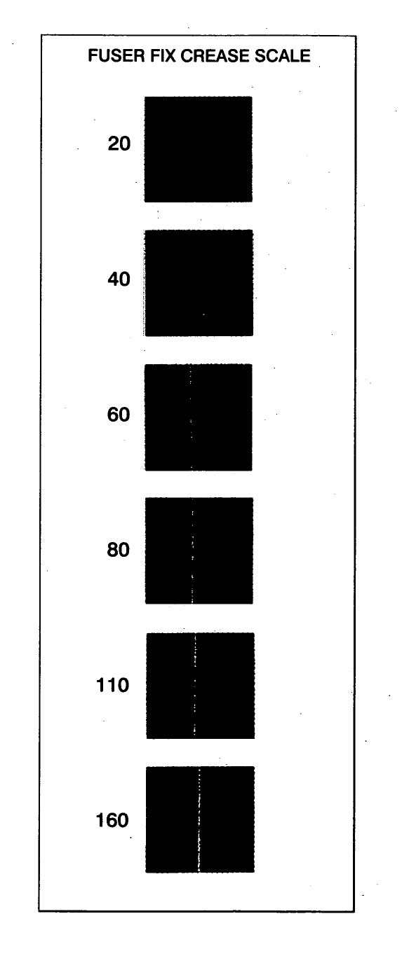

A variety of crystalline polyester toners as described in Table 1 were subject to infrared radiant fusing a Xerox® 650 CF printer utilizing a fuser with 4 lamps and 300 fpm speed. Unfused prints were made using toners of various crystalline polyester content. The prints were a solid area and the fix level was determined by a visual crease method. The crease method is as follows. Equipment and Material: Section of 9500 fuser roll (2.0 inches wide; approximately 900 gm. weight); 4 sheets of 4024 paper; cotton wad approximately 4 inch square; fused images; 2 copies each toner. Procedure: The test copy is placed on a base of 4 sheets of 4024 paper. The long end is folded across the center of the fused image. The fuser roll section is rolled across the fold applying only the pressure of the roll section. The fold is opened and wiped with the cotton wad (two wipes using moderate pressure). The same procedure is followed for 2 copies per toner. The value obtained from the two prints is averaged. Referring to the FIGURE, a visual comparison of resulting crease to the visual reference scale of the FIG. 1 is made. Refer to Table 2 for crease area vs. temperature.

The level of fix is a strong function of the crystalline polyester content of the toner. In embodiments, the toners include a range of from about 20 percent to about 60 percent crystalline polyester by weight based upon the total weight of the toner.

TABLE 1

| | Control | | | | |
|---|---|---|---|---|---|
| | Toner | Toner | Toner | Toner | Toner |
| Material | #1 | #2 | #3 | #4 | #5 |
| Crystalline Resin CPES A3C¹ | 0 | 20 | 40 | 60 | — |
| Crystalline Resin C8/C10 | — | — | — | — | 40 |
| CPE² | | | | | |
| Carbon Black | 5 | 5 | 5 | 5 | 5 |
| Embrittling Agent | 8 | 8 | 8 | 8 | 8 |
| Amorphous Resin Diacron | 17 | 17 | 17 | 17 | 17 |
| 1142B³ | | | | | |
| Amorphous Resin GTUFC115⁵ | 70 | 50 | 30 | 10 | 30 |

¹Crystalline Resin CPES A3C is a proprietary mixture of 1, 4 butanediol, fumaric acid, adipic acid available from Kao Corporation, Japan.
²Crystalline Resin C8/C10 CPE is a sebacic acid and 1, 10 decanediol resin prepared by Xerox Corporation.
³Amorphous Resin Diacron ™ 1142B is a resin commercially available from Mitsubishi Rayon.
⁴Amorphous Resin GTUFC115 = a propoxylated bisphenol A fumarate resin commercially available from Kao Corporation, Japan.

TABLE 2
Crease area vs. Crystalline Polyester Content

| | Crease |
|---|---|
| | Area |
| (Control) | 160 |
| Toner #1 | |
| Toner #2 | 95 |
| Toner #3 | 40 |
| Toner #4 | 20 |
| Toner #5 | 20 |

In embodiments, lower crease area indicates better fusing fix performance of the toner to the substrate. For example, in specific embodiments, crease area values of less than about 100 or less than about 60 or less are selected. There is a clear signal from this data that increasing levels of crystalline polyester in the toner have better fusing performance. Lower crease values indicate that less toner was removed from the paper during the crease test. This is a measure of image permanence.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A device comprising:
a charging component;
a developing component;
a transport component;
a photoconductive component; and
a radiant fusing component;
wherein the developing component contains a toner comprising at least one crystalline polymer, optionally an amorphous polymer, and at least one colorant.

2. A device in accordance with claim 1, wherein the device is a xerographic device.

3. A device in accordance with claim 1, wherein the at least one crystalline polymer is a crystalline polyester.

4. A device in accordance with claim 3, wherein the at least one crystalline polyester is present in an amount selected at from about 10 to about 80 percent by weight based upon the total weight of the toner.

5. A device in accordance with claim 3, wherein the at least one crystalline polyester is present in an amount selected at from about 20 to about 60 percent by weight based upon the total weight of the toner.

6. A device in accordance with claim 1, wherein the optional amorphous resin, is an amorphous polyester present in an amount selected at from about 20 to about 90 weight percent based upon the total weight of the toner.

7. A device in accordance with claim 1, wherein the optional amorphous resin is an amorphous polyester present in an amount selected at from about 40 to about 80 weight percent based upon the total weight of the toner.

8. The device of claim 1, wherein the at least one crystalline polymer is selected from the group consisting of a polyester comprising an alcohol selected from among 1,4-butanediol, 1,6-hexanediol, 1,10-decanediol, and mixtures thereof, and a dicarboxylic acid selected from among fumaric acid, succinic acid, oxalic acid, adipic acid, sebacic acid and mixtures thereof.

9. The device of claim 1, wherein the optional amorphous polymer is an amorphous polyester.

10. The device of claim 1, wherein the toner further comprises one or more members selected from the group consisting of a wax component, a charge additive, a surface additive, an internal additive, a surfactant, an emulsifier, a pigment dispersant, a flow additive, an embrittling agent, or mixtures or combinations thereof.

11. The device of claim 1, wherein the colorant is carbon black, magnetite, cyan, magenta, yellow, blue, green, red, orange, violet, brown, or mixtures or combinations thereof.

12. The device of claim 1, wherein the radiant fusing component is an infrared fusing device.

13. The device of claim 1, wherein the radiant fusing device is a flash fusing device.

14. An image forming apparatus for forming images on a recording medium comprising 1) a photoreceptor member having a charge retentive surface to receive an electrostatic latent image thereon, wherein said photoreceptor member comprises a metal or metallized substrate, a charge generating layer, and a single-layer charge transport layer or a two-layer charge transport layer, wherein the charge transport layer or layers comprises a charge transport material; 2) a development component to apply a developer material to said charge-retentive surface to develop said electrostatic latent image to form a developed image on said charge-retentive surface, said development component comprising a toner comprising at least one crystalline polymer, optionally an amorphous resin, and at least one colorant; 3) a transfer component for transferring said developed image from said charge-retentive surface to another member or a copy substrate; and 4) a radiant fusing component to fuse said developed image to said copy substrate.

15. A device in accordance with claim 14, wherein the at least one crystalline polymer is a crystalline polyester, and wherein the optional amorphous resin, if present, is an amorphous polyester.

16. The device of claim 15, wherein the radiant fusing component is an infrared fusing device.

17. The device of claim 15, wherein the radiant fusing component is a flash fusing device.

18. The device of claim 14, wherein the recording medium is paper and wherein a fused, printed image has a crease value of less than about 60.

19. A process for preparing a fused, printed image on a paper substrate comprising:
printing and fusing an image on a paper substrate using a device comprising a charging component, a developing component, a transport component, a photoconductive component, and a radiant fusing component, wherein the developing component contains a toner comprising at lest one crystalline polymer, optionally an amorphous polymer, and at least one colorant; and
wherein the fused, printed image has a crease value of less than about 60.

20. A process for preparing a fused, printed image on a paper substrate comprising:
printing and fusing an image on a paper substrate using a device comprising a charging component, a developing component, a transport component, a photoconductive component, and a radiant fusing component, wherein the developing component contains a toner comprising at lest one crystalline polymer, optionally an amorphous polymer, and at least one colorant.
